(19) United States
(12) Patent Application Publication
(10) Pub. No.: US 2024/0021346 A1
(43) Pub. Date: Jan. 18, 2024

(54) ELECTRONIC COMPONENT

(71) Applicant: Murata Manufacturing Co., Ltd., Nagaokakyo-shi (JP)

(72) Inventors: Tomoya OOSHIMA, Nagaokakyo-shi (JP); Yuuta HOSHINO, Nagaokakyo-shi (JP); Koichi YAMADA, Nagaokakyo-shi (JP); Miki SASAKI, Nagaokakyo-shi (JP); Hironobu KUBOTA, Nagaokakyo-shi (JP)

(21) Appl. No.: 18/475,294

(22) Filed: Sep. 27, 2023

Related U.S. Application Data
(63) Continuation of application No. PCT/JP2022/015951, filed on Mar. 30, 2022.

(30) Foreign Application Priority Data
Jun. 15, 2021 (JP) 2021-099718

(51) Int. Cl. H01C 7/04; H01C 1/14

(52) U.S. Cl. CPC H01C 7/04; H01C 1/1413

(57) ABSTRACT

An electronic component that includes: an element body; and an insulating film covering an outer surface of the element body. The element body has a crack that opens to the outer surface. In a cross section orthogonal to the outer surface, the crack has a first portion that extends from the opening and intersects an axis orthogonal to the outer surface. In addition, one portion of the insulating film penetrates into at least an inner space of the first portion of the crack.

### CROSS REFERENCE TO RELATED APPLICATIONS

The present application is a continuation of International application No. PCT/JP2022/015951, filed Mar. 30, 2022, which claims priority to Japanese Patent Application No. 2021-099718, filed Jun. 15, 2021, the entire contents of each of which are incorporated herein by reference.

### TECHNICAL FIELD

The present invention relates to an electronic component.

### BACKGROUND ART

An electronic component disclosed in Patent Document 1 includes an element body and an insulating film covering an outer surface of the element body. The insulating film is made of glass. In addition, a method for producing an electronic component disclosed in Patent Document 1 includes a chamfering step, a coating step, and a solidifying step. In the coating step, a glass slurry containing a glass powder, a binder resin, and a solvent is sprayed toward an element body formed by the chamfering step. Then the glass coating film formed by coating is dried in the solidifying step to form an insulating film.
Patent Document 1: Japanese Patent No. 3620404

### SUMMARY OF THE INVENTION

According to the method for producing an electronic component such as the one described in Patent Document 1, cracks are sometimes formed in the outer surface of the element body by the chamfering step. When the element body has cracks, these cracks may propagate upon impact from the outside against the element body, and the element body may break as a result.

To address the issues described above, the present disclosure provides an electronic component that includes: an element body that has an outer surface; and an insulating film covering at least a part of the outer surface, in which the element body has a crack with an opening that opens to the outer surface; in a cross sectional view orthogonal to the outer surface, the crack has a first portion that extends from the opening an intersects an axis orthogonal to the outer surface; and one portion of the insulating film penetrates into at least an inner space of the first portion of the crack.

According to the structure described above, when impact is applied to the electronic component from outside, the impact is received by the insulating film present in the inner space of the first portion. Thus, the impact from outside is prevented from concentrating and acting on the tip of the crack, and thus propagation of the crack can be avoided.

Propagation of cracks in the element body can be reduced.

### BRIEF DESCRIPTION OF THE DRAWINGS

FIG. 1 is a perspective view of an electronic component.

FIG. 2 is a side view of the electronic component.

FIG. 3 is a cross-sectional view taken along line 3-3 in FIG. 2.

FIG. 4 is an enlarged view of a cross section taken along line 4-4 in FIG. 2.

FIG. 5 is a diagram illustrating a method for producing an electronic component.

FIG. 6 is a diagram illustrating the method for producing an electronic component.

FIG. 7 is a diagram illustrating the method for producing an electronic component.

FIG. 8 is a diagram illustrating the method for producing an electronic component.

FIG. 9 is a diagram illustrating the method for producing an electronic component.

FIG. 10 is a diagram illustrating the method for producing an electronic component.

FIG. 11 is a table indicating comparison results of electronic components of Examples and Comparative Example.

### DETAILED DESCRIPTION OF THE PREFERRED EMBODIMENTS

### One Embodiment of Electronic Component

One embodiment of the electronic component will now be described with reference to the drawings. Note that the constituent elements are sometimes enlarged in the drawings to promote understanding. The dimensional ratio of the constituent elements may be different from the actual dimensional ratio or may be different from one drawing to another. Furthermore, although hatching is provided in a cross-sectional view, some constituent elements may be illustrated without hatching to promote understanding.

(Overall Structure)

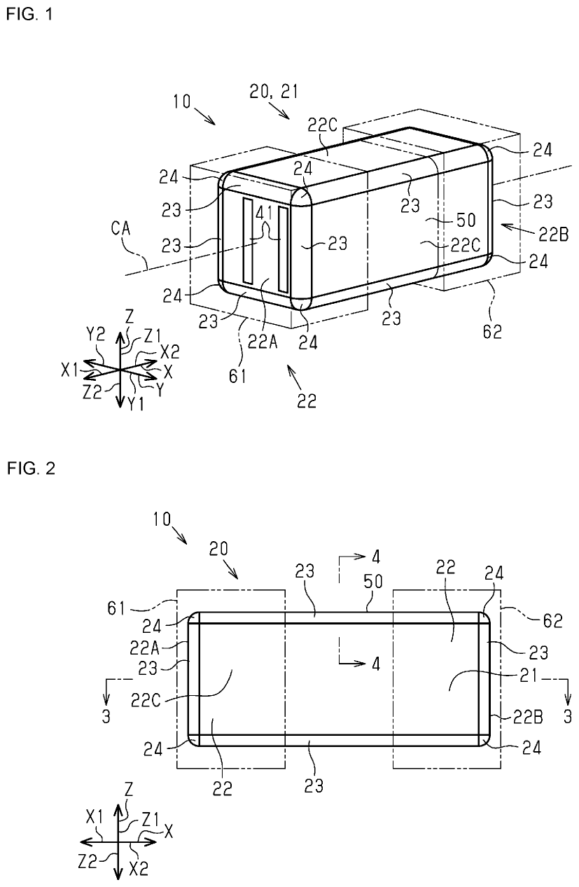

As illustrated in FIG. 1, an electronic component 10 is, for example, a surface mounting type negative temperature coefficient thermistor component to be mounted onto a circuit board or the like. Here, a negative temperature coefficient thermistor component has characteristics that the resistance value decreases with the increasing temperature.

The electronic component 10 includes an element body 20. The element body 20 is substantially quadratic prism-shaped and has a center axis CA. In the description below, an axis that extends along the center axis CA is referred to as a first axis X. One of axes orthogonal to the first axis X is referred to as a second axis Y. An axis orthogonal to the first axis X and the second axis Y is referred to as a third axis Z. One direction along the first axis X is referred to as a first positive direction X1, and a direction that runs along the first axis X but opposite to the first positive direction X1 is referred to as a first negative direction X2. One direction along the second axis Y is referred to as a second positive direction Y1, and a direction that runs along the second axis Y but opposite to the second positive direction Y1 is referred to as a second negative direction Y2. One direction along the third axis Z is referred to as a third positive direction Z1, and a direction that runs along the third axis Z but opposite to the third positive direction Z1 is referred to as a third negative direction Z2.

An outer surface 21 of the element body 20 has six flat surfaces 22. Here, the “surfaces” of the element body 20 refer to those which can be identified as surfaces when the element body 20 is observed as a whole. That is, a surface is expressed as a flat surface or a curved surface even when there are minute irregularities and level differences that are recognizable only when a part of the element body 20 is observed with a microscope or the like under magnification. The six flat surfaces 22 each spread in different directions.

The six flat surfaces 22 can be roughly classified into a first end surface 22A facing in the first positive direction X1, a second end surface 22B facing in the first negative direction X2, and four side surfaces 22C. The four side surfaces 22C are a surface facing in the third positive direction Z1, a surface facing in the third negative direction Z2, a surface facing in the second positive direction Y1, and a surface facing in the second negative direction Y2.

The outer surface 21 of the element body 20 has twelve boundary surfaces 23. The boundary surfaces 23 include curved surfaces at boundaries between adjacent flat surfaces 22. In other words, the boundary surfaces 23 include curved surfaces formed by R-chamfering corners formed between adjacent flat surfaces 22.

The outer surface 21 of the element body 20 also has eight spherical corner surfaces 24. The corner surfaces 24 are each a boundary portion among adjacent three flat surfaces 22. In other words, the corner surfaces 24 include curved surfaces at sites where three boundary surfaces 23 meet. In other words, the corner surfaces 24 include, for example, curved surfaces formed by R-chamfering corners formed between adjacent three flat surfaces 22.

In FIGS. 1 and 2, reference signs are assigned by deeming the surface of an insulating film 50 described below to be the same as the outer surface 21 of the element body 20.

As illustrated in FIG. 2, in the element body 20, the dimension in the direction along the first axis X is larger than the dimension in the direction along the third axis Z. As illustrated in FIG. 1, in the element body 20, the dimension in the direction along the first axis X is larger than the dimension in the direction along the second axis Y. The material of the element body 20 is a ceramic obtained by firing a metal oxide containing at least one element selected from Mn, Fe, Ni, Co, Ti, Ba, Al, and Zn.

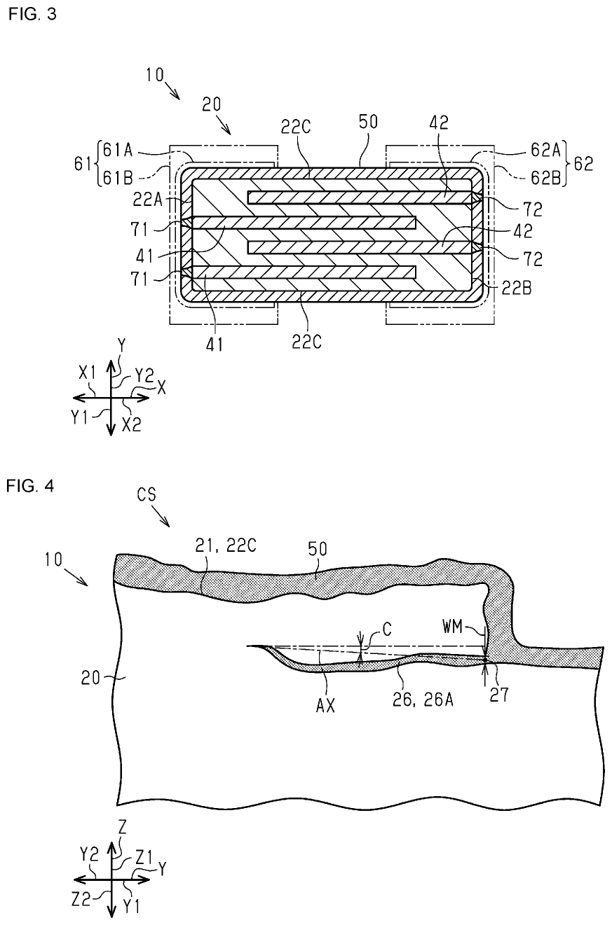

As illustrated in FIG. 3, the electronic component 10 includes two first inner electrodes 41 and two second inner electrodes 42. The first inner electrodes 41 and the second inner electrodes 42 are embedded in the element body 20.

The material of the first inner electrodes 41 is an electrically conductive material. For example, the material of the first inner electrodes 41 is palladium. The material of the second inner electrodes 42 is the same as the material of the first inner electrodes 41.

The shape of the first inner electrodes 41 is a rectangular plate shape. The main surfaces of the first inner electrodes 41 are orthogonal to the second axis Y. The shape of the second inner electrodes 42 is the same rectangular plate shape as the first inner electrodes 41. The main surfaces of the second inner electrodes 42 are orthogonal to the second axis Y as with the first inner electrodes 41.

The dimension of the first inner electrodes 41 in the direction along the first axis X is smaller than the dimension of the element body 20 in the direction along the first axis X. As illustrated in FIG. 1, the dimension of the first inner electrodes 41 in the direction along the third axis Z is about two thirds of the dimension of the element body 20 in the direction along the third axis Z. The dimensions of the second inner electrodes 42 in the respective directions are the same as the dimensions of the first inner electrodes 41.

As illustrated in FIG. 3, the first inner electrodes 41 and the second inner electrodes 42 are arranged alternately in the direction along the second axis Y. That is, from the side surface 22C facing in the second positive direction Y1, a first inner electrode 41, a second inner electrode 42, a first inner electrode 41, and a second inner electrode 42 are arranged in this order in the second negative direction Y2. In this embodiment, the distance between the inner electrodes in the direction along the second axis Y is the same.

As illustrated in FIG. 1, the two first inner electrodes 41 and the two second inner electrodes 42 are at the center of the element body 20 in the direction along the third axis Z. In contrast, as illustrated in FIG. 3, the first inner electrodes 41 are lopsided in the first positive direction X1. The second inner electrodes 42 are lopsided in the first negative direction X2.

Specifically, the first positive direction X1-side ends of the first inner electrodes 41 coincide with the first positive direction X1-side end of the element body 20. The first negative direction X2-side ends of the first inner electrodes 41 are located inside the element body 20 and fall short of reaching the first negative direction X2-side end of the element body 20. Meanwhile, the first negative direction X2-side ends of the second inner electrodes 42 coincide with the first negative direction X2-side end of the element body 20. The first positive direction X1-side ends of the second inner electrodes 42 are located inside the element body 20 and fall short of reaching the first positive direction X1-side end of the element body 20.

The electronic component 10 includes an insulating film 50. The insulating film 50 covers the outer surface 21 of the element body 20. In this embodiment, the insulating film covers all parts of the outer surface 21 of the element body 20. The material of the insulating film 50 is an insulating substance. The material of the insulating film 50 is glass. In this embodiment, glass is composed of silicon dioxide.

As illustrated in FIG. 3, the electronic component 10 includes a first outer electrode 61 and a second outer electrode 62. The first outer electrode 61 includes a first base electrode 61A and a first metal layer 61B. The first base electrode 61A is formed on the insulating film 50 in one portion of the outer surface 21 of the element body 20, the one portion including the first end surface 22A. Specifically, the first base electrode 61A is a five-surface electrode that covers the first end surface 22A of the element body 20 and a first positive direction X1-side portion of each of the four side surfaces 22C. In this embodiment, the material of the first base electrode 61A is silver and glass.

The first metal layer 61B covers the first base electrode 61A from outside. Thus, the first metal layer 61B is stacked on the first base electrode 61A. Specifically, the first metal layer 61B has a two layer structure including a nickel plating and a tin plating.

The second outer electrode 62 includes a second base electrode 62A and a second metal layer 62B. The second base electrode 62A is formed on the insulating film 50 in one portion of the outer surface 21 of the element body 20, the one portion including the second end surface 22B. Specifically, the second base electrode 62A is a five-surface electrode that covers the second end surface 22B of the element body 20 and a first negative direction X2-side portion of each of the four side surfaces 22C. In this embodiment, the material of the second base electrode 62A is silver and glass as with the material of the first outer electrode 61.

The second metal layer 62B covers the second base electrode 62A from outside. Thus, the second metal layer 62B is stacked on the second base electrode 62A. Specifically, the second metal layer 62B has a two layer structure including a nickel plating and a tin plating as with the first metal layer 61B.

The second outer electrode 62 on the side surfaces 22C falls short of reaching the first outer electrode 61 and is separated from the first outer electrode 61 in the direction along the first axis X. Then, center portions of the respective side surfaces 22C of the element body 20 in the direction along the first axis X have neither the first outer electrode 61 nor the second outer electrode 62 stacked thereon, and the insulating film 50 is exposed. Here, in FIGS. 1 to 3, the first outer electrode 61 and the second outer electrode 62 are indicated by double-dashed chain lines.

As illustrated in FIG. 3, the first outer electrode 61 and the first positive direction X1-side ends of the first inner electrodes 41 are connected via first penetrating portions 71 penetrating through the insulating film 50. Although the detailed descriptions therefor are described below, the first penetrating portions 71 are formed as palladium constituting the first inner electrodes 41 extends toward the first outer electrode 61 during the process of producing the electronic component 10.

Moreover, the second outer electrode 62 and the first negative direction X2-side ends of the second inner electrodes 42 are connected via second penetrating portions 72 penetrating through the insulating film 50. As with the first penetrating portions 71, the second penetrating portions 72 are also formed as palladium constituting the second inner electrodes 42 extends toward the second outer electrode 62 during the process of producing the electronic component 10. Note that, in FIG. 3, the first inner electrodes 41 and the first penetrating portions 71 are illustrated as separate members having boundaries; however, there are no clear boundaries between the two in actual cases. The same applies to the second penetrating portions 72. Furthermore, in FIGS. 1 and 2, the illustration of the first penetrating portions 71 is omitted.

(Crack and Insulating Film)

As illustrated in FIG. 4, the element body 20 has a crack 26. The crack 26 has an opening 27 that opens to the outer surface 21. The tip of the crack 26 is inside the element body 20.

Here, a cross section CS illustrated in FIG. 4 is taken parallel to both the second axis Y and the third axis Z. Moreover, in FIG. 4, a portion of the cross section CS including the side surface 22C facing in the third positive direction Z1 is enlarged. Thus, the cross section CS is orthogonal to a flat side surface 22C of the outer surface 21, this flat side surface 22C facing in the third positive direction Z1. Furthermore, the orthogonal axis orthogonal to the side surface 22C facing in the third positive direction Z1 is parallel to the third axis Z. Thus, the cross section CS illustrated in FIG. 4 is a cross section orthogonal to the side surface 22C.

The outer surface 21 of the element body 20 has minute irregularities. Thus, as illustrated in FIG. 4, the side surface 22C also has minute irregularities. It should be noted that even when there are minute irregularities that can only be observed under a microscope or the like, each of the side surfaces 22C of the outer surface 21 is deemed to extend parallel to the center axis CA.

In the cross section CS, the crack 26 has a first portion 26A that includes the opening 27. In this embodiment, the crack 26 is solely constituted by the first portion 26A. Here, in the cross section CS, the first portion 26A has a propagation axis AX, which is a straight line passing the center of the opening 27 and the tip of the crack 26. Here, the direction in which the first portion 26A extends is the direction heading toward the tip of the first portion 26A from the opening 27 on the propagation axis AX. Moreover, in the cross section CS, the propagation axis AX, which runs along the direction in which the first portion 26A extends, extends in a direction that intersects the third axis Z, which is the orthogonal axis.

In the cross section CS, among the angles formed between the propagation axis AX and the second axis Y, which is an axis along the direction in which the side surface 22C extends, an acute angle C is less than 45 degrees. Particularly, in this embodiment, the acute angle C among the angles formed between the propagation axis AX and the first axis X is less than 15 degrees. Thus, the crack 26 extends substantially in parallel to the side surface 22C.

In the cross section CS, the width dimension of the first portion 26A is the largest at the opening 27. The maximum value WM of the width dimension of the first portion 26A is twice or less of the film thickness, which is an average value of the thickness dimension of the insulating film 50 in the direction orthogonal to the outer surface 21. The width dimension of the first portion 26A is the length of the shortest line segment among the line segments that can be drawn from an arbitrary point on the inner wall of the first portion 26A to the opposing inner wall in the cross section CS. The film thickness, which is an average value of the thickness dimension of the insulating film 50 in the direction orthogonal to the outer surface 21, is the average of thickness dimensions of the insulating film 50 in the cross section CS measured at three sites.

One portion of the insulating film 50 penetrates into the inner space of the first portion 26A. Furthermore, one portion of the insulating film 50 fills the inner space of crack 26.

The phrase that one portion of the insulating film 50 fills the inner space of the crack 26 means that the void ratio of the inner space of the crack 26 in the cross section CS is 10% or less. The void ratio is calculated by preparing an image of the cross section CS and images indicating the mapping data of the glass component, which is a main component of the insulating film 50, and the main component of the element body 20.

Specifically, first, the site on the outer surface 21 of the element body 20 where the crack 26 is present is located with an electron microscope (SEM). Next, an EDX image indicating the EDX mapping data of the main component of the element body 20 and an EDX image indicating the EDX mapping data of the main component of the glass are acquired from the site where the crack 26 is present in the cross section CS. The EDX images are acquired with a field emission-transmission electron microscope (FE-TEM). For example, JEOL JEM-F200 produced by JEOL Ltd., and analytic system Norman system 7 produced by Thermo Fisher SCIENTIFIC Ltd. were used.

Next, the acquired EDX images are extracted as CSV files. The numerical data contained in the CSV files is matrix numerical data. The matrix numerical data is, for example, a 256×256 matrix numerical data. Each piece of such numerical data corresponds to an intensity of a small domain obtained by dividing the range of the EDX image by 256 in the vertical direction and by 256 in the horizontal direction. The matrix numerical data output as, for example, a spreadsheet format facilitates the process onwards.

Next, the numerical data of the CSV file is standardized. The maximum value of the numerical data contained in the CSV file is determined, and the value obtained by dividing 100 with this maximum value is calculated as a coefficient so that the maximum value would be 100. All numerical data in the CSV file are multiplied by the calculated coefficient. As a result, all of the numerical data can be standardized such that the maximum value of the numerical data is 100.

Next, of the standardized numerical data, all points where the intensity of the main component of the element body 20 is less than 10 are selected. Among these, a range surrounded by the ranges where the intensity of the main component of the element body 20 is 10 or more is assumed to be the range of the crack 26.

Next, of the standardized numerical data, the sites where the intensity of the main component of the glass is 10 or more are selected within the range of the crack 26. This range of the selected sites is the range filled with the glass.

Next, in the range of the crack 26, the number of pixels in the sites where the intensity of the main component of the glass is less than 10 is counted. Next, the number of pixels at the sites where the intensity of the main component of the glass is less than 10 is divided by the number of pixels in the range of the crack 26, and the result is assumed to be the void ratio. When the void ratio calculated as such is 10% or less, it is said that one portion of the insulating film 50 fills the inner space of the crack 26.

(Evaluation Test)

An electronic component 10 in which the average value of the insulating film 50 in the thickness direction was 100 nm was subjected to an impact test to evaluate whether breaking occurred. The impact test is a test that applies a predetermined impact onto the electronic component 10.

Here, when the maximum value WM of the width dimension of the crack 26 was 10 nm and the void ratio was 0%, the electronic component 10 did not break in the impact test. When the maximum value WM of the width dimension of the crack 26 was 50 nm and the void ratio was 0%, the electronic component 10 did not break in the impact test. Furthermore, when the maximum value WM of the width dimension of the crack 26 was 100 nm and the void ratio was 10%, the electronic component 10 did not break in the impact test. Meanwhile, in a comparative example where the maximum value WM of the width dimension of the crack 26 was 300 nm and the void ratio was 15%, the electronic component 10 broke in the impact test. The breaking refers to partial delamination between the element body 20 and the insulating film 50.

### Embodiment of Method for Producing Electronic Component

(Overall Structure)

Next, a method for producing the electronic component is described.

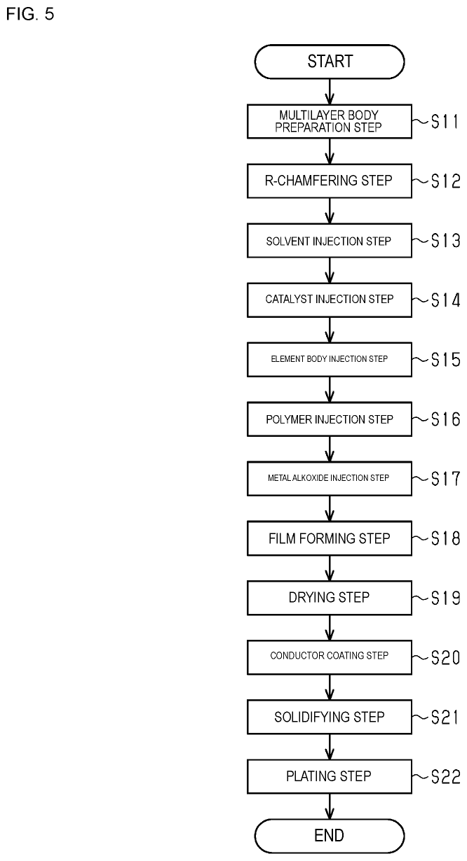

As illustrated in FIG. 5, the method for producing the electronic component 10 includes a multilayer body preparation step S11, an R-chamfering step S12, a solvent injection step S13, a catalyst injection step S14, an element body injection step S15, a polymer injection step S16, and a metal alkoxide injection step S17. The method for producing the electronic component 10 further includes a film forming step S18, a drying step S19, a conductor applying step S20, a solidifying step S21, and a plating step S22.

First, in forming the element body 20, in the multilayer body preparation step S11, a multilayer body, which is an element body 20 not having boundary surfaces 23 or corner surfaces 24, is prepared. In other words, the multilayer body is a rectangular parallelepiped body having six flat surfaces 22 in a state before the R-chamfering. For example, multiple ceramic sheets that form the element body 20 are prepared first. The sheets have a thin sheet shape. A conductive paste that forms a first inner electrode 41 is stacked onto the sheet. Then a ceramic sheet that forms the element body 20 is stacked on the stacked paste. Then a conductive paste that forms a second inner electrode 42 is stacked onto the sheet. As such, the ceramic sheets and the conductive paste are stacked. The resulting stack is cut into a particular size to form a green multilayer body. The green multilayer body is then fired at a high temperature to prepare a multilayer body.

Next, the R-chamfering step S12 is performed. In the R-chamfering step S12, boundary surfaces 23 and corner surfaces 24 are formed on the multilayer body prepared in the multilayer body preparation step S11. For example, by R-chamfering the corners of the multilayer body by barrel polishing, the boundary surfaces 23 that have curved surfaces and the corner surfaces 24 that have curved surfaces are formed. As a result, an element body 20 is formed. Moreover, the crack 26 is formed in the element body 20 by the impact applied by barrel polishing.

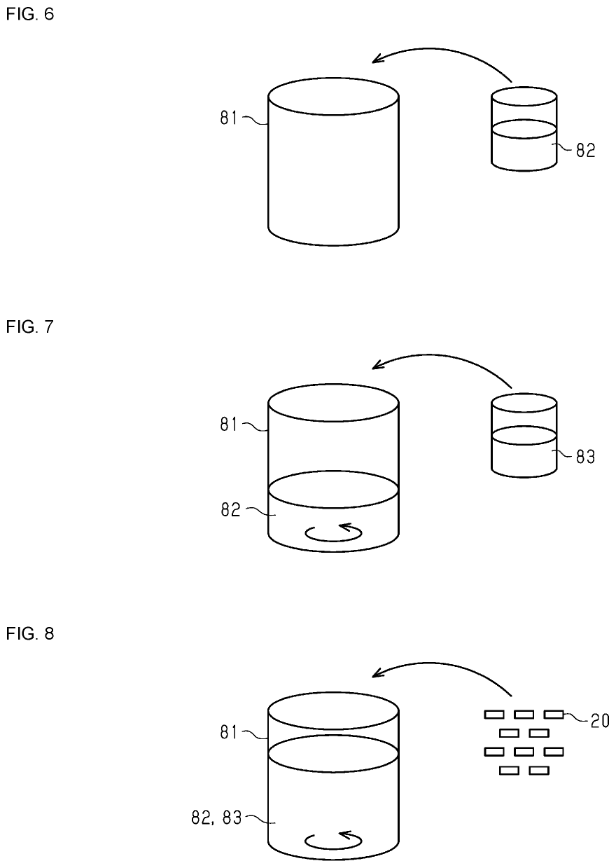

Next, the solvent injection step S13 is performed. As illustrated in FIG. 6, in the solvent injection step S13, 2-propanol is injected as a solvent 82 into a reactor 81.

Next, as illustrated in FIG. 5, the catalyst injection step S14 is performed. As illustrated in FIG. 7, in the catalyst injection step S14, first, stirring of the solvent 82 in the reactor 81 is started. Next, ammonia water is injected as a catalyst-containing aqueous solution 83 into the reactor 81. The catalyst in this embodiment is a hydroxide ion which serves as a catalyst that accelerates the hydrolysis of a metal alkoxide 85 described below.

Next, as illustrated in FIG. 5, the element body injection step S15 is performed. As illustrated in FIG. 8, in the element body injection step S15, multiple element bodies 20, which have been formed in the R-chamfering step S12 as described above, are injected into the reactor 81.

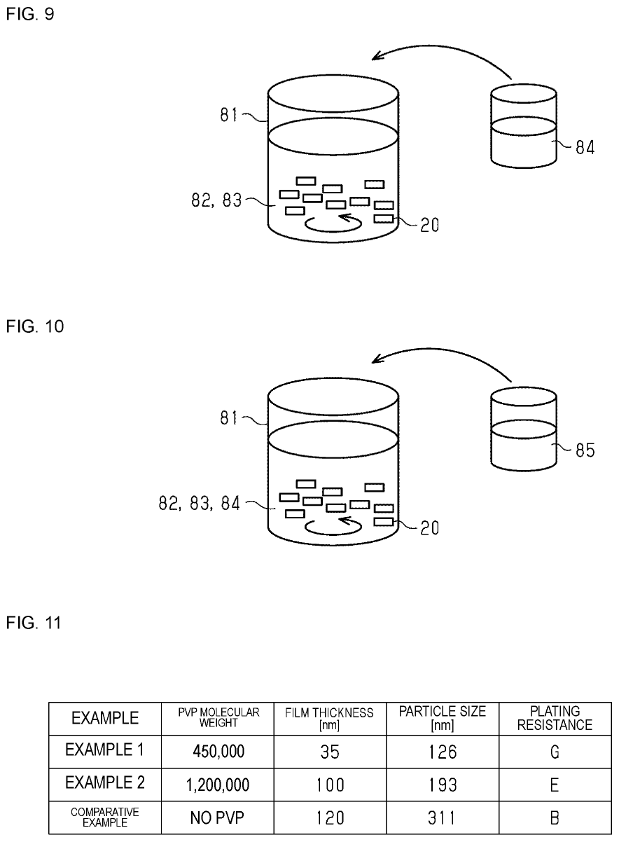

Next, as illustrated in FIG. 5, the polymer injection step S16 is performed. As illustrated in FIG. 9, in the polymer injection step S16, polyvinylpyrrolidone is injected as a polymer 84 into the reactor 81. As a result, the polymer 84 injected into the reactor 81 adsorb onto the outer surfaces 21 of the element bodies 20.

Next, as illustrated in FIG. 5, the metal alkoxide injection step S17 is performed. As illustrated in FIG. 10, in the metal alkoxide injection step S17, liquid tetraethyl orthosilicate is injected as the metal alkoxide 85 into the reactor 81. Here, tetraethyl orthosilicate is also called tetraethoxysilane. In this embodiment, the amount of the metal alkoxide 85 injected in the metal alkoxide injection step S17 is calculated on the basis of the area of the outer surfaces 21 of the element bodies 20 injected in the element body injection step S15. Specifically, the amount is calculated by multiplying the amount of the metal alkoxide 85 necessary for forming an insulating film 50 covering the outer surface 21 of one element body 20 with the number of the element bodies 20.

Next, as illustrated in FIG. 5, the film forming step S18 is performed. In the film forming step S18, stirring of the solvent 82 started in the aforementioned solvent injection step S13 is continued for a predetermined time after the injection of the metal alkoxide 85 into the reactor 81 in the metal alkoxide injection step S17.

In the film forming step S18, an insulating film 50 is formed by a liquid phase reaction in the reactor 81. In this liquid phase reaction, the metal alkoxide 85 and the like contained in the solvent 82 are in a liquid phase, and thus flow into the inner space of the crack 26. Then an insulating film 50 is formed on the inner walls of the crack 26 also by the liquid phase reaction.

Next, the drying step S19 is performed. In the drying step S19, after stirring is continued for a predetermined time in the film forming step S18, the element bodies 20 are discharged from the reactor 81 and dried. As a result, the sol-state insulating films 50 are dried and form gel-state insulating films 50. Here, in this embodiment, the solvent injection step S13, the catalyst injection step S14, the element body injection step S15, the polymer injection step S16, the metal alkoxide injection step S17, and the film forming step S18 constitute the method for forming an insulating film 50 on an element body 20.

Next, the conductor applying step S20 is performed. In the conductor applying step S20, a conductor paste is applied to two portions of the surface of the insulating film 50, that is, a portion that includes a portion that covers the first end surface 22A of the element body 20 and a portion that includes a portion that covers the second end surface 22B of the element body 20. Specifically, the conductor paste is applied so as to cover the insulating film 50 on the entire first end surface 22A and one portion of each of the four side surfaces 22C. Furthermore, the conductor paste is applied so as to cover the insulating film 50 on the entire second end surface 22B and one portion of each of the four side surfaces 22C.

Next, the solidifying step S21 is performed. Specifically, the solidifying step S21 involves heating the insulating film 50 and the element body 20 onto which the conductor paste is applied. As a result, water and the polymer 84 evaporate from the gel-state insulating film 50, and, thus, as illustrated in FIG. 3, the insulating film 50 covering the outer surface 21 of the element body 20 is fired and solidified. As a result, the first base electrode 61A and the second base electrode 62A are formed as a result of firing the conductor paste applied in the conductor applying step S20. As such, the conductor applying step S20 and the solidifying step S21 constitute a base electrode forming step. In other words, the solidifying step S21 of this embodiment serves not only as the step for solidifying the insulating film 50 but also as a part of the base electrode forming step.

In this embodiment, during heating performed in the solidifying step S21, palladium contained in the first inner electrodes 41 is drawn toward the silver-containing first base electrode 61A due to the Kirkendall effect caused by the difference in the diffusion speed between the first inner electrodes 41 and the first base electrode 61A. As a result, the first penetrating portions 71 penetrate through the insulating film 50 and extend from the first inner electrodes 41 to the first base electrode 61A, and thus the first inner electrodes 41 become connected to the first base electrode 61A. This same applies to the second penetrating portions 72 that connect the second inner electrodes 42 and the second base electrode 62A.

Next, the plating step S22 is performed. Electroplating is performed on the first base electrode 61A and the second base electrode 62A. As a result, a first metal layer 61B is formed on the surface of the first base electrode 61A. Furthermore, a second metal layer 62B is formed on the surface of the second base electrode 62A. Although not illustrated in the drawings, the first metal layer 61B and the second metal layer 62B are each electro-plated with two metals, nickel and tin, and thus have a two-layer structure. As a result, an electronic component 10 is formed.

(Comparison Results Due to Difference in PVP Molecular Weight)

Here, Examples 1 and 2 of the electronic component 10 produced by the aforementioned production method and the electronic component of Comparative Example were compared for the thickness of the insulating film 50, the particle size of the glass particles present on the surface of the insulating film 50, and the plating resistance.

As illustrated in FIG. 11, in the electronic component 10 of Example 1, the molecular weight of polyvinylpyrrolidone used as the polymer 84 is 45,000. In the electronic component 10 of Example 2, the molecular weight of polyvinylpyrrolidone used as the polymer 84 is 1,200,000. The electronic component of Comparative Example was produced by omitting the polymer injection step S16 so that no polymer 84 was used. The electronic components 10 of Examples 1 and 2 and the electronic component of Comparative Example were produced by using the same amount of the metal alkoxide 85.

The thickness of the insulating films 50 of the electronic components 10 of Examples 1 and 2 and the electronic component of Comparative Example was measured. The thickness of the insulating film 50 was measured at a cross section CS that passed through the center of the element body 20 in the direction along the first axis X and that is orthogonal to the center axis CA. In the cross section CS illustrated in FIG. 4, the dimension in the direction orthogonal to the outer surface 21 was measured at three points from the outer surface 21 of the element body 20 to the surface of the insulating film 50, and the average value of these three points was assumed to be the film thickness of the insulating film 50.

The thickness of the insulating film 50 of the electronic component 10 of Example 1 was 35 nm. The thickness of the insulating film 50 of the electronic component 10 of Example 2 was 100 nm. The thickness of the insulating film 50 of the electronic component of Comparative Example was 120 nm.

The particle size of the glass particles present on the surface of the insulating film 50 was measured from the electronic components 10 of Examples 1 and 2 and the electronic component of Comparative Example.

The particle size is the size of glass particles that are present in a particular ratio or more on the surface of the insulating film 50. For example, of the side surfaces 22C, surfaces of portions not covered with the first outer electrode 61 or the second outer electrode 62 were observed with an electron microscope. Next, in the observation range, a very small quantity of large particles formed by aggregation of particles were excluded, and the average value of the diameters of the rest of the particles was calculated.

The particle size was 126 nm in the electronic component 10 of Example 1. The particle size was 193 nm in the electronic component 10 of Example 2. The particle size was 311 nm in the electronic component of Comparative Example.

The plating resistance of the electronic components 10 of Examples 1 and 2 and the electronic component of Comparative Example was evaluated. The plating resistance is a property of preventing the element body 20 from dissolving in the plating solution. The plating solution is used to form the first outer electrode 61 and the second outer electrode 62. In evaluating the plating resistance, a sample prepared by forming an insulating film 50, a first base electrode 61A, and a second base electrode 62A on an element body 20 is used as the evaluation sample. Next, the evaluation sample is plated with nickel. For the evaluation sample after nickel plating, at least two adjacent surfaces of the outer surface 21 of the element body 20 are photographed under a ring light. In sites where the outer surface 21 of the element body 20 is exposed, the area percent of the portions where the element body has eluted is measured for each surface by image processing, and the average value is calculated. A sample with an area ratio average of 0% to 5% is rated E (excellent). A sample with an area ratio average of more than 5% and 20% or less is rated G (good). A sample with an area ratio average of more than 20% is rated B (bad).

The plating resistance of the electronic component 10 of Example 1 was G (good). The plating resistance of the electronic component 10 of Example 2 was E (excellent). The plating resistance of the electronic component of Comparative Example was B (bad).

(Observations Regarding Difference in PVP Molecular Weight During Film Forming Process)

As mentioned above, the inventors have found that the thickness of the insulating film 50, the coarse particle size of the glass particles, and plating resistance change according to the difference in molecular weight of the polymer 84. Thus, the film forming process and the difference in the molecular weight of the polymer 84 were examined.

First, comparing the absence/presence of the polymer 84, in the electronic component of Comparative Example that does not use the polymer 84, the glass particles grow relatively fast, and thus the particle size is large. Then the large glass particles attach to the surface of the element body 20 one after next, resulting in a large thickness of the insulating film 50.

Meanwhile, in the electronic components 10 of Examples 1 and 2 that use the polymer 84, it is considered that the presence of the polymer 84 inhibited the growth of the glass particles compared to the case of Comparative Example. Furthermore, similarly, it is considered that the polymer 84 attached to the element body 20 inhibits attachment of the glass particles to the surface of the element body 20, and thus, the excessive increase in the thickness of the insulating film 50 could be avoided.

Regarding the difference in molecular weight of the polymer 84, for a space of the equal size, the polymer 84 is densely gathered when the molecular weight of the polymer 84 is small compared to when the molecular weight of the polymer 84 is large. It is considered that this has promoted inhibition of growth of the glass particles. It is considered that, as a result, in the electronic component 10 of Example 1 in which the molecular weight of the polymer 84 is small, the particle size was small and the thickness was small compared to the electronic component 10 of Example 2.

Furthermore, if the size of the glass particles is the same, the larger the thickness, the higher the plating resistance; however, it was found that, if the size of the glass particles is excessively large, the plating resistance is rated B irrespective of the thickness. This is presumably because, when the particle size is excessively large and when impact from outside the element body 20 is applied to the vicinity of the glass particles having large particle size, such particles would delaminate the insulating film 50 from the outer surface 21 of the element body 20. Thus, from the viewpoint of the plating resistance, the electronic component of Example 2, in which the particle size was appropriately reduced and the thickness was increased, is preferable.

(Mechanism of Embodiments)

Assume that a portion of the insulating film 50 fails to penetrate into the inner space of the crack 26 and the inner space of the crack 26 remains unfilled. In such a case, when impact is applied from outside the electronic component the impact sometimes concentrates and acts on the tip of the crack 26. In such a case, the crack propagates from the tip of the crack 26. Then the element body 20 breaks as the parts flanking the crack 26 move away from each other.

(Effects of Embodiments)

(1) According to the aforementioned embodiment, one portion of the insulating film 50 penetrates into the inner space of the crack 26. Thus, when an impact is applied from outside the electronic component 10, the impact is received by the insulating film 50 present in the inner space of the crack 26. Thus, the impact from outside is prevented from concentrating and acting on the tip of the crack 26, and thus propagation of the crack 26 can be avoided.

(2) According to the aforementioned embodiment, in the cross section CS, among the angles formed between the side surface 22C and the propagation axis AX in which the first portion 26A extends, the acute angle C is less than 15 degrees. Thus, one portion of the insulating film 50 penetrates into the first portion 26A of the crack 26 extending in such a direction that partial delamination of the element body 20 may be caused. Thus, partial delamination of the element body 20 attributable to propagation of the crack 26 can be appropriately reduced.

(3) According to the embodiment described above, in the cross section CS, the maximum value WM of the width dimension of the first portion 26A is twice or less of the average value of the insulating film 50 in the thickness direction orthogonal to the side surface 22C. Thus, the thickness of the insulating film 50 is sufficiently large with respect to the width dimension of the first portion 26A of the crack 26. In other words, there is an enough amount of the insulating film 50 to fill the inner space of the crack 26. Thus, it is easy to secure the amount of the insulating film 50 penetrating the inner space of the crack 26.

(4) According to the embodiment described above, the material of the element body 20 is a ceramic. Thus, the element body 20 is prone to develop a crack 26 during its production process. Thus, the effect of reducing chipping or the like of the element body 20 can be prominently obtained as the insulating film 50 penetrates into the inner space of the crack 26.

(5) When a glass slurry is sprayed, it is difficult to have the slurry reach the inner space of the crack 26. Even if this is possible, it is necessary to adjust the direction in which the crack 26 extends and the direction of spraying the glass slurry and control the size of the particles of the glass slurry. Regarding this point, in the aforementioned embodiment, the metal alkoxide 85 and other substances in a liquid phase contained in the solvent 82 flow into the crack 26. Thus, the insulating film 50 can be formed inside the crack 26 in the film forming step S18 without having to adjust the glass slurry spraying direction or the glass slurry particle size during the production process.

(6) According to the method for producing the electronic component 10 of the embodiment described above, large-size glass particles are less likely to be present on the surface of the insulating film 50. Thus, the insulating film 50 near large glass particles is prevented from delaminating from the outer surface 21 of the element body 20 upon impact from outside the element body 20.

### OTHER EMBODIMENTS

The embodiments described above can be implemented with the following modifications and alterations. The aforementioned embodiments and the modification examples described below can be combined and implemented unless there is technical inconsistencies.

In the aforementioned embodiment, the electronic component 10 is not limited to the negative temperature coefficient thermistor component. For example, it may be a thermistor component that is not of a negative temperature coefficient type, a multilayer capacitor component, or an inductor component.

The material of the element body 20 is not limited to the examples described in the embodiment above. The material of the element body 20 may be a composite body of a resin and a metal powder.

The shape of the element body 20 is not limited to the examples described in the embodiment above. For example, the element body 20 may have a polygonal prismatic shape other than the rectangular prismatic shape having the center axis CA. Moreover, the element body 20 may be a core of a winding inductor component. For example, the core may have a so-called a drum core shape. Specifically, the core may have a columnar winding core portion and flanges respectively disposed at end portions of the winding core portion.

The outer surface 21 of the element body 20 does not have to have corner surfaces 24 including curved surfaces. For example, when boundaries of the adjacent flat surfaces 22 of the outer surface 21 of the element body 20 are not chamfered, there are no curved surfaces at these boundaries. Thus, at a site where three of such boundaries meet, there may be no corner surface 24 that includes a curved surface.

In the embodiment described above, the crack 26 may have other portions in addition to the first portion 26A. For example, in the cross section CS, the crack 26 may have a first portion 26A that extends to intersect the third axis Z, which is an orthogonal axis, and a second portion that connects to the first portion 26A and extends along a direction different from that of the first portion 26A. In such a case, the second portion may extend along the third axis Z, which is an orthogonal axis.

In the cross section CS, a propagation axis AX that passes through the center of the opening 27 of the crack 26 and an arbitrary point of the crack 26 is drawn. Then the arbitrary point of the crack 26 is gradually moved away from the opening 27 to draw propagation axes AX in the same manner. A large number of propagation axes AX are drawn as described above, and the point of the crack 26 at which the propagation axis AX has first become parallel to the second axis Y is determined as a specific point. The first portion 26A is a portion of the crack 26 that extends from the center of the opening 27 of the crack 26 to the aforementioned specific point (however, the specific point is excluded). In other words, the first portion 26A is a portion that lies directly below with respect to the opening 27 of the crack 26 in the direction along the second axis Y, excluding the specific point. Note that when the propagation axis AX fails to become parallel to the second axis Y even when the arbitrary point is moved away as far as the tip of the crack 26, the entire crack 26 is the first portion 26A as in the aforementioned embodiment.

According to the aforementioned embodiment, in the cross section CS, among the angles formed between the side surface 22C and the propagation axis AX, the acute angle C may be 15 degrees or more. When the acute angle C is less than 45 degrees and when a production method that involves spraying a glass slurry to form an insulating film 50 is employed, for example, the glass slurry does not easily penetrate into the crack 26. Regarding this point, according to the production method of the aforementioned embodiment, the insulating film 50 is formed as the reaction progresses in the first portion 26A of the crack 26, which is more preferable. Moreover, even when the acute angle C is 45 degrees or more, one portion of the insulating film 50 penetrates into the crack 26, and thus an effect of reducing breaking of the element body 20 is obtained.

In the embodiment described above, the maximum value WM of the width dimension of the first portion 26A may be more than twice the average value of the insulating film 50 in the thickness direction. At least one portion of the insulating film 50 is to penetrate into the first portion 26A.

In the embodiment described above, the width dimension of the first portion 26A may be the largest at a site other than the opening 27. In other words, the maximum value WM of the width dimension of the first portion 26A may be the width dimension of the site other than the opening 27.

In the embodiment described above, the shape of the first inner electrodes 41 and the second inner electrodes 42 may be any shape as long as electrical conduction between the corresponding first outer electrode 61 and second outer electrode 62 can be secured. The number of the first inner electrodes 41 and the second inner electrodes 42 may be any, and the number of the first inner electrodes 41 may be 1 or may be 3 or more.

The structure of the first outer electrode 61 is not limited to the example of the embodiment described above. For example, the first outer electrode 61 may be solely constituted by the first base electrode 61A, and the first metal layer 61B does not have to have a two-layer structure. Note that, when the first outer electrode 61 includes the first metal layer 61B, the insulating film 50 covers the entirety of the outer surface 21 of the element body 20, and thus an effect of suppressing dissolution of the element body 20 in the plating solution can be obtained. The same applies to the second outer electrode 62.

In the embodiment described above, the combination of the materials of the first inner electrodes 41 and the first base electrode 61A is not limited to the combination of palladium and silver. For example, the combination may be copper and nickel, copper and silver, silver and gold, nickel and cobalt, or nickel and gold. Alternatively, for example, the one may be silver and the other may be a combination of silver and palladium. Alternatively, for example, the one may be palladium and the other may be a combination of silver and palladium, or the one may be copper and the other may be a combination of silver and palladium. Alternatively, for example, the one may be gold and the other may be a combination of silver and palladium.

It should be noted that, depending on the combination of the first inner electrodes 41 and the first base electrode 61A, the Kirkendall effect does not always occur. In such a case, for example, a portion of the insulating film 50 may be physically removed by polishing the first end surface 22A-side of the element body 20 to expose the first inner electrodes 41 prior to the outer electrode forming step. The first inner electrodes 41 can be connected to the first base electrode 61A by subsequently performing the base electrode forming step. In addition, for example, after formation of the first base electrode 61A, an insulating film 50 may be formed also on the surface of the first base electrode 61A and then the insulating film 50 covering the surface of the first base electrode 61A may be removed. The same applies to the combination of the materials of the second inner electrodes 42 and the second base electrode 62A.

The site where the first outer electrode 61 is disposed is not limited to the example of the embodiment described above. For example, the first outer electrode 61 may be disposed on the first end surface 22A and one of the side surfaces 22C. The same applies to the second outer electrode 62.

The insulating film 50 does not have to cover all parts of the outer surface 21 of the element body 20. In other words, some portion of the outer surface 21 of the element body 20 may be exposed from the insulating film 50. The range to be covered by the insulating film 50 may be modified as appropriate according to the shape of the element body 20, the positions of the first outer electrode 61 and the second outer electrode 62, etc.

In the portion of the insulating film 50 covered by the first base electrode 61A, the glass in the insulating film 50 may diffuse into the glass in the first base electrode 61A, thereby integrating the insulating film 50 and the first base electrode 61A.

The material of the insulating film 50 is not limited to the examples described in the embodiment above. For example, the glass is not limited to silicon dioxide, and may be Si-containing multicomponent oxide such as oxides based on B—Si, Si—Zn, Zr—Si, and Al—Si. Furthermore, glass may be a multicomponent oxide containing an alkali metal and Si, such as oxides based on Al—Si, Na—Si, K—Si, and Li—Si. Furthermore, glass may be a multicomponent oxide containing an alkaline earth metal and Si, such as oxides based on Mg—Si, Ca—Si, Ba—Si, and Sr—Si. Moreover, glass may be free of Si or a mixture of any of the foregoing.

The material of the insulating film 50 may contain, in addition to glass, a surface treatment agent or an antistatic agent such as a pigment, a silicone flame retardant, a silane coupling agent, or a titanate coupling agent.

More specifically, the insulating film 50 may contain, in addition to glass, an organic acid salt, an oxide, an inorganic salt, an organic salt, and an additive of fine particles and nanoparticles of metal oxide.

Examples of the organic acid salt include salts of oxo acids such as soda ash, sodium carbonate, sodium hydrogen carbonate, sodium percarbonate, sodium sulfite, sodium hydrogen sulfite, sodium sulfate, sodium thiosulfate, sodium nitrate, and sodium sulfite, and halogen compounds such as sodium fluoride, sodium chloride, sodium bromide, and sodium iodide.

An example of the oxide is sodium peroxide, and an example of the hydroxide is sodium hydroxide.

Examples of the inorganic salt include sodium hydride, sodium sulfide, sodium hydrogen sulfide, sodium silicate, trisodium phosphate, sodium borate, sodium borohydride, sodium cyanide, sodium cyanate, and sodium tetrachloroaurate.

Examples of the inorganic salt include calcium peroxide, calcium hydroxide, calcium fluoride, calcium chloride, calcium bromide, calcium iodide, calcium hydride, calcium carbide, and calcium phosphide.

The additive may be an oxo acid salt such as calcium carbonate, calcium hydrogen carbonate, calcium nitrate, calcium sulfate, calcium sulfite, calcium silicate, calcium phosphate, calcium pyrophosphate, calcium hypochlorite, calcium chlorate, calcium perchlorate, calcium bromate, calcium iodate, calcium arsenite, calcium chromate, calcium tungstate, calcium molybdate, calcium magnesium carbonate, or hydroxyapatite. Further examples of the additive include calcium acetate, calcium gluconate, calcium citrate, calcium malate, calcium lactate, calcium benzoate, calcium stearate, and calcium aspartate.

For example, the additive may be lithium carbonate, lithium chloride, lithium titanate, lithium nitride, lithium peroxide, lithium citrate, lithium fluoride, lithium hexafluorophosphate, lithium acetate, lithium iodide, lithium hypochlorite, lithium tetraborate, lithium bromide, lithium nitrate, lithium hydroxide, lithium aluminum hydride, lithium triethylborohydride, lithium hydride, lithium amide, lithium imide, lithium diisopropylamide, lithium tetramethylpiperidide, lithium sulfide, lithium sulfate, lithium thiophenolate, or lithium phenoxide.

For example, the additive may be boron triiodide, sodium cyanoborohydride, sodium borohydride, tetrafluoroboric acid, triethylborane, borax, or boric acid.

For example, the additive may be potassium arsenide, potassium bromide, potassium carbide, potassium chloride, potassium fluoride, potassium hydride, potassium iodide, potassium triiodide, potassium azide, potassium nitride, potassium superoxide, potassium ozonide, potassium peroxide, potassium phosphide, potassium sulfide, potassium selenide, potassium telluride, potassium tetrafluoroaluminate, potassium tetrafluoroborate, potassium tetrahydroborate, potassium methanide, potassium cyanide, potassium formate, potassium hydrogen fluoride, potassium tetraiodomercurate(II), potassium hydrogen sulfide, potassium octachlorodimolybdate(II), potassium amide, potassium hydroxide, potassium hexafluorophosphate, potassium carbonate, potassium tetrachlorideplatinate(II), potassium hexachlorideplatinate(IV), potassium nonahydridorhenate(VII), potassium sulfate, potassium acetate, gold(I) potassium cyanide, potassium hexanitritocobaltate(III), potassium hexacyanoferrate(III), potassium hexacyanoferrate(II), potassium methoxide, potassium ethoxide, potassium tert-butoxide, potassium cyanate, potassium fulminate, potassium thiocyanate, aluminum potassium sulfate, potassium aluminate, potassium arsenate, potassium bromate, potassium hypochlorite, potassium chlorite, potassium chlorate, potassium perchlorate, potassium carbonate, potassium chromate, potassium dichromate, potassium tetrakis(peroxo)chromate(V), potassium cuprate(III), potassium ferrate, potassium iodate, potassium periodate, potassium permanganate, potassium manganate, potassium hypomanganate, potassium molybdate, potassium nitrite, potassium nitrate, tripotassium phosphate, potassium perrhenate, potassium selenate, potassium silicate, potassium sulfite, potassium sulfate, potassium thiosulfate, potassium disulfite, potassium dithionate, potassium disulfate, potassium peroxodisulfate, potassium dihydrogen arsenate, dipotassium hydrogen arsenate, potassium hydrogen carbonate, potassium dihydrogen phosphate, dipotassium hydrogen phosphate, potassium hydrogen selenate, potassium hydrogen sulfite, potassium hydrogen sulfate, or potassium hydrogen peroxosulfate.

For example, the additive may be barium sulfite, barium chloride, barium chlorate, barium perchlorate, barium peroxide, barium chromate, barium acetate, barium cyanide, barium bromide, barium oxalate, barium nitrate, barium hydroxide, barium hydride, barium carbonate, barium iodide, barium sulfide, or barium sulfate. In addition, the additive may be sodium acetate or sodium citrate.

The additive may be fine particles or nanoparticles of a metal oxide, and examples of the metal oxide include sodium oxide, calcium oxide, lithium oxide, boron oxide, potassium oxide, barium oxide, silicon oxide, titanium oxide, zirconium oxide, aluminum oxide, zinc oxide, and magnesium oxide.

In the method for producing the electronic component of the aforementioned embodiment, the metal alkoxide 85 is not limited to the examples in the aforementioned embodiment. Examples of the element that can synthesize the metal alkoxide include Li, Be, B, C, Na, Mg, Al, Si, P, K, Ca, Sc, Ti, V, Cr, Mn, Fe, Co, Ni, Cu, Zn, Ga, Ge, As, Rb, Sr, Y, Zr, Nb, Mo, Cd, In, Sn, Sb, Cs, Ba, La, Ce, Pr, Nd, Pm, Sm, Eu, Gd, Tb, Dy, Ho, Er, Tm, Yb, Lu, Hf, Ta, W, Hg, Tl, Pb, Bi, Th, Pa, U, and Pu. The alkoxides of these elements can be used as a precursor of glass.

For example, the metal alkoxide 85 may be sodium methoxide, sodium ethoxide, calcium diethoxide, lithium isopropoxide, lithium ethoxide, lithium tert-butoxide, lithium methoxide, boron alkoxide, potassium t-butoxide, tetraethyl orthosilicate, allyltrimethoxysilane, isobutyl(trimethoxy)silane, tetrapropyl orthosilicate, tetramethyl orthosilicate, [3-(diethylamino)propyl]trimethoxysilane, triethoxy(octyl)silane, triethoxyvinylsilane, triethoxyphenylsilane, trimethoxyphenylsilane, trimethoxymethylsilane, butyltrichlorosilane, n-propyltriethoxysilane, methyltrichlorosilane, dimethoxy(methyl)octylsilane, dimethoxydimethylsilane, tris(tert-butoxy)silanol, tris(tert-pentoxy)silanol, hexadecyltrimethoxysilane, dipotassium tris(1,2-benzenediolate-0,0′)silicate, tetrabutyl orthosilicate, aluminum silicate, calcium silicate, a tetramethylammonium silicate solution, chlorotriisopropoxytitanium(IV), titanium(IV) isopropoxide, titanium(IV) 2-ethylhexyl oxide, titanium(IV) ethoxide, titanium(IV) butoxide, titanium(IV) tert-butoxide, titanium(IV) propoxide, titanium(IV) methoxide, zirconium(IV) bis(diethyl citrate) dipropoxide, zirconium(IV) dibutoxide (bis-2,4-pentanedionate), zirconium(IV) 2-ethylhexanoate, a zirconium(IV) isopropoxide isopropanol complex, zirconium(IV) ethoxide, zirconium(IV) butoxide, zirconium(IV) tert-butoxide, zirconium(IV) propoxide, aluminum tert-butoxide, aluminum isopropoxide, aluminum ethoxide, aluminum-tri-sec-butoxide, or aluminum phenoxide.

In the method for producing the electronic component of the aforementioned embodiment, a metal complex or an acetate salt that serves as a precursor of the metal alkoxide may be used instead of the metal alkoxide 85. In such a case, in the metal alkoxide injection step S17, the metal complex or the acetate salt that serves as a precursor of the metal alkoxide may be injected. Examples of the metal complex include acetyl acetonates such as lithium acetylacetonate, titanium(IV) oxyacetylacetonate, titanium diisopropoxide bis(acetylacetonate), zirconium(IV) trifluoroacetylacetonate, zirconium(IV) acetylacetonate, aluminum acetylacetonate, aluminum(III) acetylacetonate, calcium(II) acetylacetonate, and zinc(II) acetylacetonate. In addition, the examples of the acetate salt include zirconium acetate, zirconium(IV) acetate hydroxide, and basic aluminum acetate.

In the method for producing the electronic component 10 of the aforementioned embodiment, the base electrode forming step is not limited to the examples in the aforementioned embodiment. For example, the insulating film 50 may be solidified by performing a heat treatment after the film forming step S18, and then the conductor applying step S20 and the solidifying step S21 may be performed to form the first base electrode 61A and the second base electrode 62A. In addition, for example, as described in the modification example above, when some portion of the first inner electrodes 41 is exposed from the insulating film 50, the first outer electrode 61 may be formed on the exposed portion by a plating technique.

The solidifying step S21 is not limited to the step of solidifying the insulating film 50 and the conductor paste simultaneously. For example, if the conductor paste is a material solidified by UV irradiation, a heating step may be performed as the solidifying step of solidifying the insulating film 50 and then UV irradiation may be performed as the step of solidifying the conductor paste.

In the method for producing the electronic component described above, the insulating film 50 may be solidified in the drying step S19 by sufficiently evaporating water and the polymer 84. In such a case, the drying step S19 functions as the solidifying step of solidifying the insulating film 50.

In the method for producing the electronic component described above, the order in which the solvent injection step S13, the catalyst injection step S14, and the element body injection step S15 are performed may be any. This is as long as the metal alkoxide 85 reacts with the catalyst in the reactor 81 in the state in which the solvent 82, the element body 20, and the polymer 84 are injected into the reactor 81.

In the method for producing the electronic component described above, the polymer 84 is not limited to polyvinylpyrrolidone. For example, the polymer 84 may be a homopolymer or a copolymer of acrylics, such as acrylic acid or methacrylic acid, or esters thereof. Examples of the acrylics include acrylic acid ester copolymers, methacrylic acid ester copolymers, and acrylic acid ester-methacrylic acid ester copolymers. For example, the polymer 84 is a homopolymer or a copolymer of cellulose, polyvinyl alcohol, polyvinyl acetate, polyvinyl chloride, or polypropylene carbonate. Examples of the cellulose include hydroxypropyl cellulose, cellulose ether, carboxymethyl cellulose, acetylcellulose, and acetylnitrocellulose. The polymer 84 may contain multiple polymers and may contain at least one selected from those examples described above.

In the method for producing the electronic component 10 of the aforementioned embodiment, the solvent 82 is not limited to 2-propanol. The solvent 82 may be changed as appropriate as long as the metal alkoxide 85 can be sufficiently dispersed.

Meanwhile, the film forming method disclosed in Japanese Unexamined Patent Application Publication No. 2020-36002 includes a solvent injection step, a catalyst injection step, an element body injection step, and a metal alkoxide injection step. Moreover, the film forming method includes a film forming step. In the film forming step, an insulating film made of silicon oxide is formed on the outer surface of the element body by hydrolysis and polycondensation reaction of a metal alkoxide.

According to the film forming method disclosed in Japanese Unexamined Patent Application Publication No. 2020-36002, the size of silicon oxide may become excessively large. When large silicon oxide particles are present on the surface of the insulating film and when the impact is applied to the vicinity of these particles from outside the element body, these particles may cause delamination of the insulating film in the vicinity from the outer surface of the element body.

According to the film forming method in the method for producing the electronic component 10 described above, the polymer 84 is injected in the polymer injection step S16. During the process of forming the insulating film 50, the polymer 84 adsorbs onto the outer surface 21 of the element body 20. In the subsequent metal alkoxide injection step S17, the glass fine particles derived from the metal alkoxide 85 are captured by the polymer 84. Thus, coarse glass particles that have grown excessively can no longer be captured by the polymer 84. As a result, excessively large particles are not contained in the insulating film 50.

As such, from the viewpoint of reducing the excessive growth of glass coarse particles, the crack 26 in the element body 20 is not an essential feature. Moreover, there is no need for a portion of the insulating film 50 to penetrate into the crack 26 in the element body 20.

Moreover, the glass coarse particles can be further made smaller by controlling the concentration of the metal alkoxide 85, the alkali concentration, the reaction temperature, the reaction time, the type of the solvent 82, the surface charges of the element body 20, etc.

A technical idea that can be identified from the aforementioned embodiments and modification examples is as follows.

<Appendix 1>

A film forming method for forming a metal oxide-containing insulating film on an outer surface of an element body, the method including: injecting the element body into a reactor; injecting, into the reactor, a polymer that adsorbs onto an outer surface of the element body; injecting, into the reactor, a metal alkoxide or a metal alkoxide precursor; injecting, into the reactor, a catalyst that accelerates hydrolysis of the metal alkoxide; and subjecting the metal alkoxide to hydrolysis and dehydration synthesis so as to form the insulating film on the outer surface of the element body.

### REFERENCE SIGNS LIST

10 electronic component
20 element body
21 outer surface
26 crack
26A first portion
27 opening
41 first inner electrode
42 second inner electrode
50 insulating film
61 first outer electrode
62 second outer electrode
71 first penetrating portion
72 second penetrating portion
81 reactor
82 solvent
83 aqueous solution
84 polymer
85 metal alkoxide
85A glass fine particles
85B glass coarse particles

1. An electronic component comprising:
an element body that has an outer surface; and
an insulating film covering at least part of the outer surface,
wherein the element body has a crack with an opening that opens to the outer surface,
in a cross sectional view orthogonal to the outer surface, the crack has a first portion that extends from the opening and intersects an axis orthogonal to the outer surface, and
one portion of the insulating film penetrates into at least an inner space of the first portion of the crack.

2. The electronic component according to claim 1,
wherein, in the cross-sectional view orthogonal to the outer surface, an acute angle selected from angles formed between the outer surface and a propagation axis along a direction in which the first portion of the crack extends is less than 45 degrees.

3. The electronic component according to claim 2,
wherein, in the cross-sectional view orthogonal to the outer surface, the acute angle selected from angles formed between the outer surface and the propagation axis is less than 15 degrees.

4. The electronic component according to claim 1,
wherein, in the cross-sectional view orthogonal to the outer surface, a maximum value of a width dimension of the first portion of the crack is twice or less of an average value of a thickness dimension of the insulating film in a direction orthogonal to the outer surface.

5. The electronic component according to claim 4, wherein the width dimension of the first portion of the crack is largest at the opening.

6. The electronic component according to claim 1, wherein a material of the element body is a ceramic.

7. The electronic component according to claim 1, wherein the crack extends substantially in parallel to the outer surface.

8. The electronic component according to claim 1, wherein a void ratio of the inner space of the crack in the cross section is 10% or less.

9. The electronic component according to claim 8, wherein a maximum value of a width dimension of the first portion of the crack is 100 nm or less.

10. The electronic component according to claim 1, wherein a maximum value of a width dimension of the first portion of the crack is 100 nm or less.

11. The electronic component according to claim 1, wherein a material of the insulating film is glass.

12. The electronic component according to claim 11, wherein the glass is silicon dioxide.

13. The electronic component according to claim 11, wherein the glass is selected from Si-containing multicomponent oxides, multicomponent oxides containing an alkali metal and Si, and multicomponent oxides containing an alkaline earth metal and Si.
